(19) United States
(12) Patent Application Publication
(10) Pub. No.: US 2016/0270891 A1
(43) Pub. Date: Sep. 22, 2016

(54) VIBRATION GENERATOR FOR GENERATING MECHANICAL VIBRATIONS

(71) Applicant: KALTENBACH & VOIGT GMBH, Biberach (DE)

(72) Inventor: Michael Aaron Fisher, Bala Cynwyd, PA (US)

(21) Appl. No.: 14/663,607

(22) Filed: Mar. 20, 2015

(51) Int. Cl. A61C 17/20; A61C 5/06; A61C 1/07; H02K 7/06; H02K 7/116

(52) U.S. Cl. CPC A61C 17/20; H02K 7/061; H02K 7/116; A61C 1/07; A61C 5/062

(57) ABSTRACT

Vibration generator for generating mechanical vibrations for a dental handpiece, comprising a rotation driving means, a vibration generating element rotationally coupled to the rotation driving means and comprising an imbalanced vibrating portion and a vibrating element in mechanical communication with the vibration generating element, wherein the rotation of the vibration generating element causes the imbalanced vibrating portion to generate vibrations of the vibrating element and the vibrating element is configured to deliver the vibrations to an object.

### BACKGROUND

The present invention relates to a vibration generator for generating mechanical vibrations for a dental handpiece, wherein the vibration generator comprises a rotation driving means, a vibration generating element and a vibrating element.

### SUMMARY

Vibration generators for dental handpieces are currently used in both dental scalers and dental handpieces for delivering restoration composites.

Regarding the usage of vibration generators in dental scalers, it should be in general noted that in medical or dental medical technologies, a treatment of the human or animal body, or artificial parts thereof (prostheses) can be effected with a tool of a treatment instrument in various ways. In many cases, there is necessary merely a treatment of the body without alternation of its shape. Here, there may be involved e.g. a surface treatment in the manner of a massage. Another kind of treatment consists in altering the shape of the body, such as it is the case e.g. with a material removing working. This treatment instruments of the kind concerned, appropriately designed, the tool is set into oscillation respectively vibration by means of an oscillatory drive respectively vibration generator, wherein the frequency lies in particular in the sonic or ultrasonic range.

Regarding the usage of vibration generators in dental handpieces for delivering restoration composites, it should be noted that in general in medical technology it is known to fill, and therefore to repair, cavities in an animal or human body part or in a prosthesis with a filler material, e.g. after material removing working of a defect. For this, curable filler masses are used, which are brought into the cavity in a pasty or liquid condition and then harden. Currently, for example dental masses are used, which contain a binder or such a high proportion of filler materials that the dental mass itself is difficult to use for the intended purpose due to its high viscosity. However, by supplying oscillation energy respectively vibration energy, the viscosity of for example a pasty filler mass can be reduced to a more easily usable value.

In both areas, dental scalers as well as dental handpieces for delivering restoration composites, different kinds of oscillation drives or vibration generators are currently in use. On the one hand, some devices comprise a piezo function, which generates a vibration in the sonic or ultrasonic range. On the other hand, other devices are known, which comprise a pneumatic function that again generates a vibration in the sonic or ultrasonic range.

Two different kinds of generating a vibration are shown in DE 100 39 198 A1 and DE 10 2005 028 925 A1, wherein in these documents on the one side, a dental scaler and on the other side a dental handpiece for delivering restoration composites is shown. As further examples for dental scalers and dental handpieces for delivering restoration composites, it is referred to the products SONICflex and SONICfill of the applicant Kaltenbach & Voigt GmbH.

Each kind of generating a vibration has different disadvantages. For example, it is not possible to adjust the frequency and amplitude independently from each other when using a conventional pneumatic device. Another drawback is that in pneumatic devices it is required that the output air must be exhausted. Thereby, the exhaust port must be designed to avoid directing the pressurized air into the patient's open tooth/root as the air can cause discomfort and/or contaminate the tooth.

It is therefore an object of the present invention to propose an alternative generator for generating vibrations for a dental handpiece.

This object is achieved by means of the features of the independent claims. The dependent claims further develop the central idea of the present invention.

The present invention relates to a vibration generator for generating mechanical vibrations for a dental handpiece, which comprises a rotation driving means, a vibration generating element and a vibrating element. The vibration generating element is rotationally coupled to the rotation driving means and comprises an imbalanced vibrating portion. The vibrating element is in mechanical communication with the vibration generating element. Further, the rotation of the vibration generating element causes the imbalanced vibrating portion to generate vibrations of the vibrating element, wherein the vibrating element is configured to deliver the vibrations to an object.

The present invention therefore is a new solution for generating mechanical vibrations for a dental handpiece.

The imbalanced vibrating portion can be an imbalanced flywheel, wherein the imbalanced flywheel in particular can be formed by a disk comprising at least one imbalancing hole or opening, the imbalancing hole or opening being offset from an axis of rotation of the vibration generating element.

Further, the imbalanced vibrating portion can comprise a shape having at least one cut-away portion, the cut-away portion being offset from an axis of rotation of the vibration generating element.

Advantageously, the vibration generator can further comprise at least one speed-increasing gear provided between the rotation driving means and the vibration generating element, wherein the at least one speed-increasing gear in particular comprises a gear train of at least two consecutive speed-increasing gears provided between the rotation driving means and the vibration generating element.

In addition, the vibration generator can comprise a second vibration generating element in mechanical communication with the vibrating element, wherein the rotation of the second vibration generating element generates vibration of the vibrating element. Thereby, the rotational speeds of the two vibration generating elements can be the same and the vibration generator can further comprise means for adjusting a phase between rotational movements of the two vibration generating elements.

The vibration generator can also comprise a second vibration generating element rotationally coupled to a driving shaft of the rotation driving means, wherein the vibrating element supports the first and second vibration generating elements and the vibration generator further comprises means for adjusting a phase of the rotational movement of the two vibration generating elements.

Thereby, the means for adjusting a phase of the rotational movement of the two vibration generating elements comprise a gear train transferring a rotation of the drive shaft to one of the two vibration generating elements, wherein the gear train comprises a phase-adjustment gear portion and the phase-adjustment gear portion in particular comprises a bevel gear arrangement, wherein one beveled gear wheel of the bevel gear arrangement is displaceable around a longitudinal axis of the gear train to adjust a phase of rotation of the corresponding vibration generating element.

The rotation driving means can comprise a motor, in particular an electric motor.

Further, the vibrations can have a displacement amplitude between 5 micrometers and 500 micrometers. Preferably, the vibrations have a displacement amplitude between 50 micrometers and 200 micrometers. Further preferably, the vibrations have a displacement amplitude of approximately 100 micrometers.

The object can also comprise a container containing a substance having a physical property that changes under vibration, wherein the physical property in particular comprises a viscosity, and the object further comprises a tip for providing the substance, for example to a tooth.

The object can comprise a vibratable treatment instrument, in particular a scaler tip, and a body part in a patient's oral cavity, wherein the body part in particular comprises a tooth.

The present invention further shows a dental handpiece for dispensing a pasty filler mass, the viscosity of which can be used by supplying vibration energy, wherein the handpiece has a handpiece housing, means for holding a container for the pasty filler mass and a vibration generator and the vibration generator is a generator according to one of the above-described.

Alternatively, the present invention shows a dental handpiece comprising an elongated gripping sleeve, a vibratable treatment instrument, in particular a scaler tip, arranged at one end of the gripping sleeve and a vibration generator arranged in the gripping sleeve to generate vibrations, wherein the vibration generator is a generator according to one of the above-described. This handpiece can be a dental scaler.

The present invention further relates to a method for manufacturing a dental handpiece, comprising the steps of providing a rotation driving means, imbalancing an object to form an imbalanced vibrating portion, providing a vibration generating element rotationally coupled to the rotation driving means and comprising the imbalanced vibrating portion and providing a vibrating element in mechanical communication with vibration generating element, wherein the rotation of the vibration generating element causes the imbalanced vibrating portion to generate vibrations of the vibrating element and the vibrating element is configured to deliver the vibrations to an object.

As mentioned above, the present invention can be an alternative to a pneumatic vibration generator or a piezo vibration generator, wherein the vibration generator of the present invention generates mechanical vibrations for a dental handpiece by using, for example, an imbalanced flywheel, which is for example driven by an electric motor. The imbalanced flywheel then generates vibrations of a vibrating element, wherein the vibrations are then delivered by the vibrating element to an object as a tooth or a container containing a substance.

These and other aspects and advantages of the present invention will become more apparent when studying the following detailed description, in connection with the figures.

### BRIEF DESCRIPTION OF THE DRAWINGS

FIG. 1a shows a dental handpiece for dispensing a pasty filler mass comprising a vibration generator according to the present invention.

FIG. 1b shows a dental scaler comprising a vibration generator according to the present invention.

FIG. 2 shows three different imbalanced flywheels in a top view.

FIG. 3 shows three different imbalanced flywheels in a side view.

FIG. 4 shows a dental handpiece for dispensing a pasty filler mass comprising a vibration generator according to the present invention.

FIG. 5 shows a dental handpiece for dispensing a pasty filler mass comprising a vibration generator according to the present invention and the combination of a first imbalanced flywheel with a second imbalanced flywheel.

FIG. 6 shows a dental handpiece for dispensing a pasty filler mass comprising a vibration generator according to the present invention.

FIG. 7 shows a dental handpiece for dispensing a pasty filler mass comprising a vibration generator according to the present invention.

FIG. 8 shows a dental handpiece for dispensing a pasty filler mass comprising a vibration generator according to the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

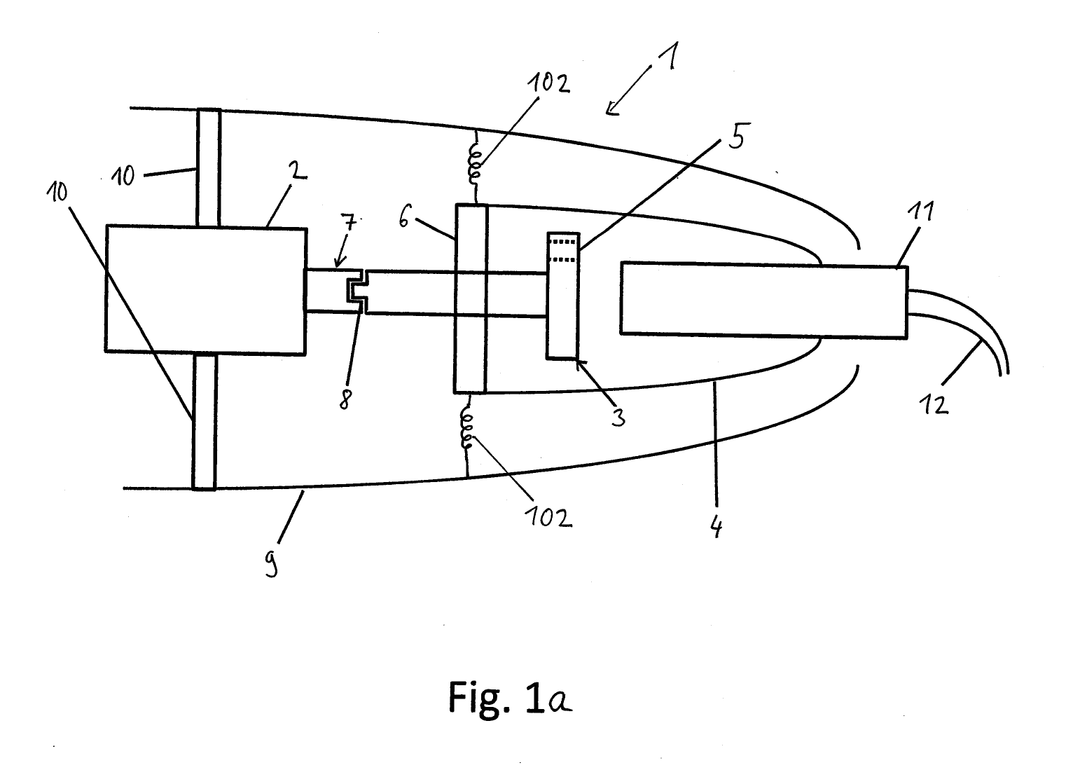

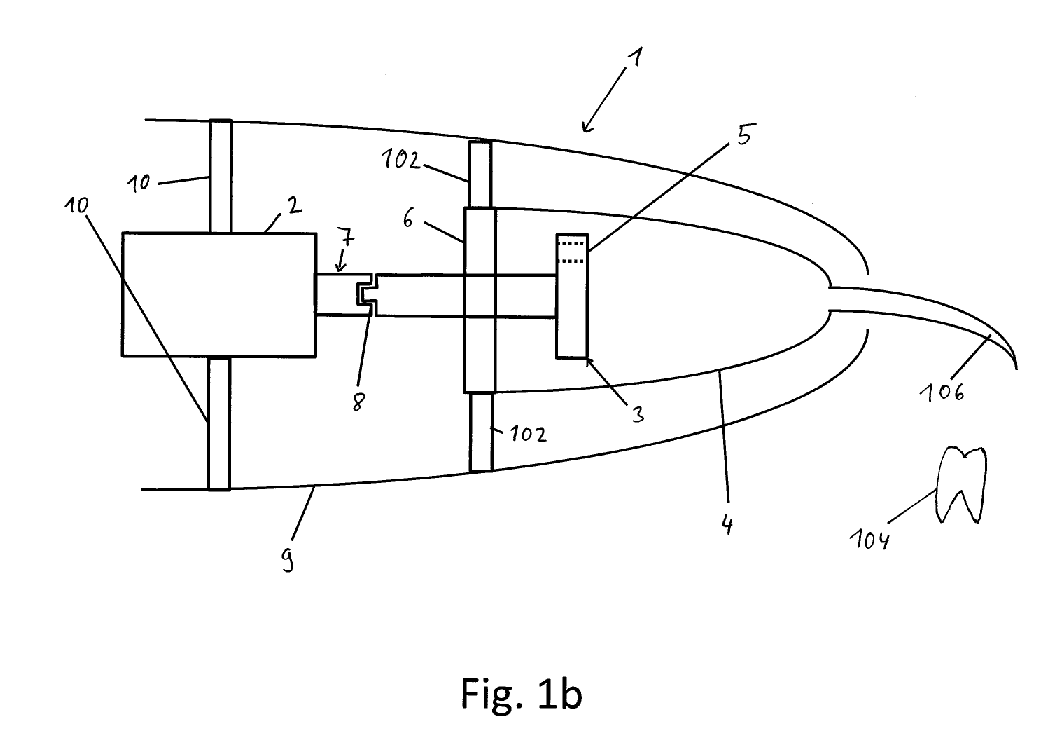

The dental handpieces shown in the FIGS. 1a and 4-8 can be used for delivering restoration composites, e.g. for dispensing a pasty filler mass, whose viscosity can be reduced by supplying vibration energy. Each dental handpiece shown in the FIGS. 1a and 4-8 comprises a handpiece housing, a container containing the pasty filler mass, means for holding the container and a vibration generator, wherein the vibrations of the vibration generator are delivered to the container and a tip for providing the pasty filler mass, for example to a tooth.

As already described above, the present invention provides an alternative solution for generating oscillations respectively vibrations for a dental handpiece. Therefore, the vibration generator of the present invention can be used not only for a dental handpiece for delivering restoration composites, but also for dental scalers, as it is shown in FIG. 1b. In this case, a dental handpiece would then comprise an elongated gripping sleeve, a vibratable treatment instrument, in particular a scaler tip, arranged at one end of the gripping sleeve and the vibration generator arranged in the gripping sleeve to generate vibrations, wherein the vibrations are then delivered to the vibratable treatment instrument and a body part in a patient's oral cavity. The body part in a patient's oral cavity can be for example a tooth. Preferably, the vibrations have an amplitude large enough to clean or scale the tooth, but small enough to avoid damaging the tooth.

In view of the already mentioned products of the applicant Kaltenbach & Voigt GmbH, it should be noted that in the following the dental handpieces in the FIGS. 1a and 4-8 are described regarding the SONICfill products. In addition, a vibration generator of the present invention can of course also be used in the SONICflex products as in FIG. 1b.

The currently known devices for generating a vibration have, as cited above, different disadvantages. Therefore, the present invention provides an alternative solution of a vibration generator for generating mechanical vibrations for a dental handpiece.

FIG. 1a now shows a dental handpiece 1 with a vibration generator. The vibration generator comprises a rotation driving means 2, a vibration generating element and a vibrating element 4. The vibration generating element is rotationally coupled to the rotation driving means 2 and comprises an imbalanced vibrating portion 3 and the vibrating element 4 is in mechanical communication with the vibration generating element, wherein the rotation of the vibration generating element causes the imbalanced vibrating portion 3 to generate vibrations of the vibrating element 4 and the vibrating element 4 is configured to deliver the vibrations to an object 11, 12.

In FIG. 1a the rotation driving means is a motor 2, in particular a DC or AC electric motor, which spins the vibration generating element and thus the imbalanced vibrating portion, which is in FIG. 1a an imbalanced flywheel 3 and is in particular formed by a disk. The imbalanced disk or flywheel 3 then comprises at least one imbalancing hole or opening 5, wherein this imbalancing hole or opening 5 is off set from an axis of rotation of the vibration generating element, wherein this off center hole or opening 5 can be, for example drilled in an easy and simple way in the imbalanced disk or flywheel 3.

The vibrating element, which in FIG. 1a is an inner vibration transmitting member 4, is positioned in the dental handpiece 1 inside a handpiece housing respectively outer case 9, which surrounds the motor 2, all the parts of the vibration generating element and the vibrating element 4.

In the example illustrated in FIG. 1a, the imbalanced flywheel 3 is positioned inside the vibrating element 4 so that the rotation of the vibration generating element by the motor 2 causes the imbalanced flywheel 3 to generate vibrations of the vibrating element 4. But optionally, the imbalanced flywheel 3 can be also positioned outside the vibrating element 4. Further the vibrating element 4 in FIG. 1a partly covers a container 11 containing for example restoration composites, wherein the container 11 is connected with a tip 12 for providing the restoration composites, for example to a tooth. But optionally, the vibrating element 4 does not need to cover any part of the container 11. The container 11 could be for example a SONICfill capsule of the applicant and can then be further connected to a so-called SONICfill tip as a tip 12 for providing the restoration composites, for example to a tooth.

The container 11 is now positioned in such a way and arranged in view of the vibrating element 4 that the vibrating element 4 can deliver the vibrations to the container 11. As mentioned above, the container 11 can contain a substance having a physical property that changes under vibration, for example a restoration composite for tooth, wherein the physical property in particular comprises a viscosity. For example, the restoration composite can comprise a thixotropic material.

In the example illustrated in FIG. 1a, the vibrating element 4 is affixed to the outer case/housing 9 through one or more compliant mounts 102 to keep the vibrating element 4 positioned within the outer case 9 while allowing the vibrating element 4 to vibrate. In FIG. 1a, the compliant mounts are illustrated schematically as one or more springs 102, but optionally they can comprise any compliant structure, e.g. a rubber or polymer O-ring or one or more members formed from any other compliant material.

In FIG. 1a it can be further seen that the motor 2, which spins the vibration generating element and thus the imbalanced flywheel 3, is mounted in the outer case 9 by motor mounts 10. In addition, the imbalanced flywheel 3 is coupled to the motor 2 via a driving shaft 7, which optionally comprises a rotational coupler 8. The imbalanced flywheel 3 is therefore rotationally coupled to the motor 2. To keep the driving shaft 7 in position, the dental handpiece 1 in FIG. 1a further comprises a bearing 6.

As already mentioned above, FIG. 1b shows a dental handpiece 1 with a vibration generator, wherein the dental handpiece 1 is a dental scaler. Similar to the dental handpiece 1 in FIG. 1a, the dental handpiece 1 in FIG. 1b also comprises a motor 2, an imbalanced flywheel 3 with an imbalancing hole or opening 5, a vibrating element 4, a bearing 6, a driving shaft 7, a rotational coupler 8, an outer case 9, motor mounts 10 and compliant mounts 102. In difference to the dental handpiece 1 in FIG. 1a, the dental handpiece 1 in FIG. 1b does not comprise a container and a tip for providing restoration composites. Instead, a scaler tip 106 as a vibratable treatment instrument is provided, which is in contact with the vibrating element 4, so that the vibrations of the vibrating element 4 can be delivered to the scaler tip 106 and further to a tooth 104 as a body part in a patient's oral cavity to clean or scale the tooth 104.

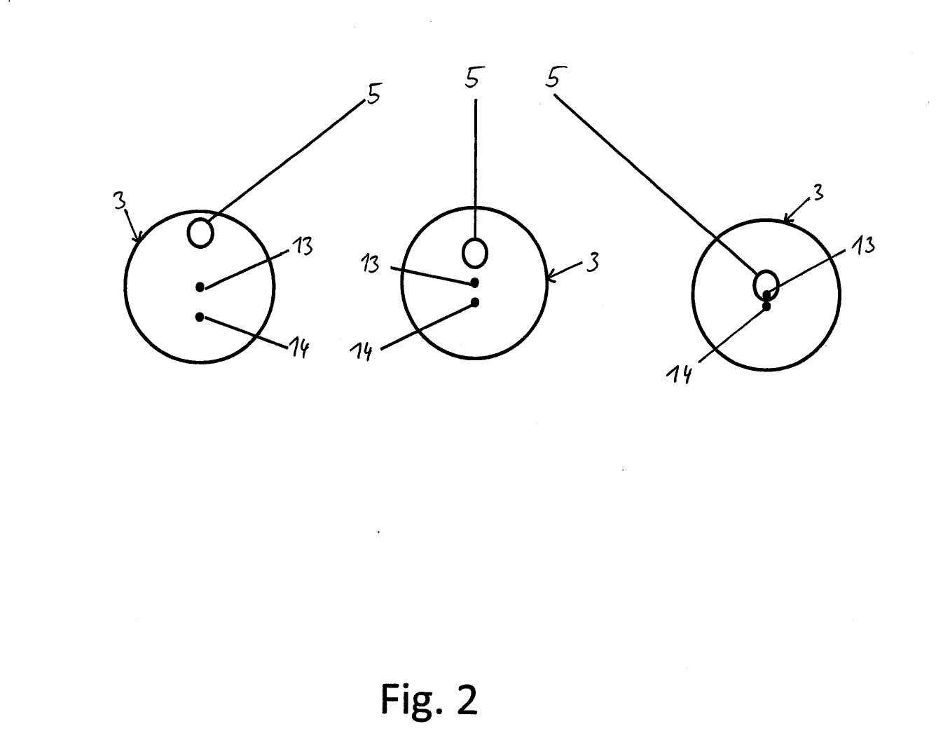

FIG. 2 now shows three different imbalanced flywheels 3, wherein the distance between the imbalancing hole 5 causing the imbalance and the axis of rotation respectively center of rotation 13 of the imbalanced flywheel 3 differs from one to the other imbalanced flywheel 3. Here, it should be noted that the distance between the hole 5 and the center of rotation 13 determines the center of mass 14 of the imbalanced flywheel 3 and thus determines the amount of imbalance.

As mentioned above, in FIG. 2 the three imbalanced flywheels 3 have each a different distance between the hole 5 and the center of rotation 13, wherein the imbalanced flywheel 3 on the left side of FIG. 2 has the biggest distance, the imbalanced flywheel 3 on the right side of FIG. 2 has the smallest distance and the imbalanced flywheel 3 in the middle of FIG. 2 has a medium distance. Therefore, the imbalanced flywheel 3 on the left side has a strong imbalance, the imbalanced flywheel 3 in the middle has a moderate imbalance and the imbalanced flywheel 3 on the right side has a weak imbalance. By changing the imbalance of the imbalanced flywheel 3, it is possible to change the amplitude of the vibrations, wherein, at a given angular velocity, a greater imbalance will produce higher-amplitude vibrations. Preferably, the amount of imbalance is selected such that, at the normal operating speed of the imbalanced flywheel 3, the amplitude of the vibrations is sufficient to reduce the viscosity of the restoration composite to a level at which the composite is easy work with, yet the vibrations are not so strong as to cause discomfort to the patient.

For example, a vibration displacement amplitude of approximately 100 μm (microns or micrometers) at a frequency of 6 kHz is optimal for some restoration composites. This can be expressed in terms of velocity amplitude—for example restoration composites have been known to work at a velocity amplitude of about 600 mm/s. However, the invention is not limited to these specific amplitudes. For example, some composites can exhibit a noticeable thixotropic effect with vibration amplitudes as low as 50 μm, 5 μm, or even lower. Furthermore, a useful handpiece can generate vibration amplitudes as large as 200 μm, 500 μm, or even more. Thus, in some exemplary cases the optimal vibration amplitude(s) can be within the range of 5-500 μm, or within the range of 50-200 μm. However, higher or lower amplitudes are also contemplated to be within the present inventive concept.

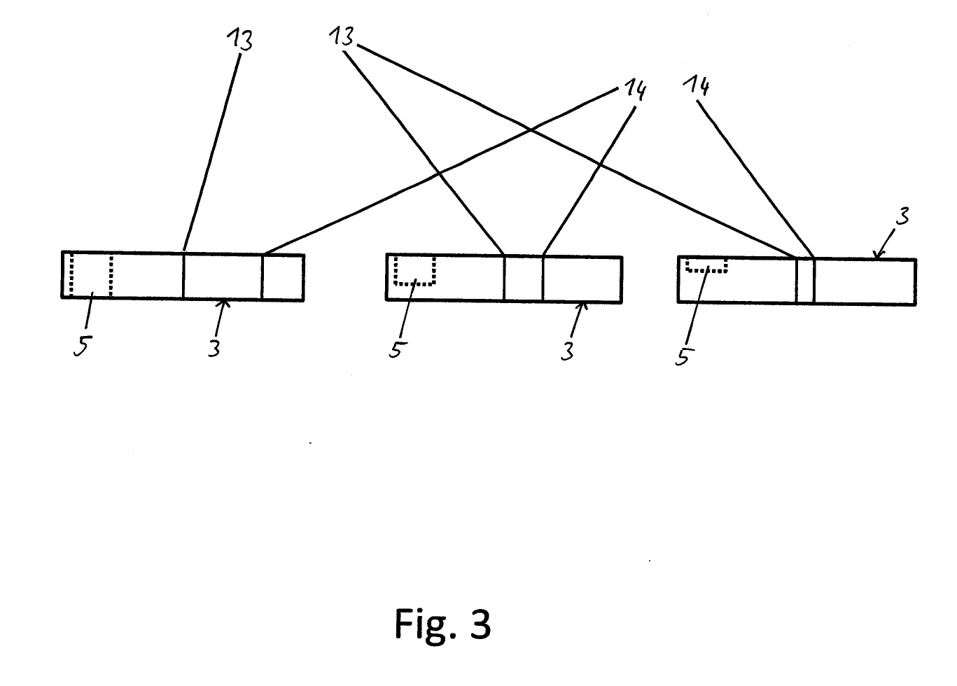

An alternative solution to change the imbalance of the imbalanced flywheel 3 is shown in FIG. 3. There, again three different imbalanced flywheels 3 are shown, however, the distance between the imbalancing hole 5 and the center of rotation 13 is always the same. To change the amount of imbalance, the depth of the hole 5 is now changed or adjusted, as it is shown in FIG. 3. As can be seen from FIG. 3, a higher depth of the hole 5 causes that the center of mass 14 is more far away from the center of rotation 13 and thus a higher or stronger imbalance is the result. This is shown in detail in the imbalanced flywheel 3 on the left side of FIG. 3. In difference thereto, a smaller depth of the hole 5 causes, as shown on the right side of FIG. 3, that the center of mass 14 is closer to the center of rotation 13 and thus a weaker imbalance is the result. The imbalanced flywheel 3 in the middle of FIG. 3 shows a medium or moderate depth of the hole 5, which causes a moderate imbalance.

In FIGS. 2 and 3 two different possibilities are shown to change or adjust the amount of imbalance of the imbalanced flywheel 3. It should be noted that both possibilities, changing the distance between the hole 5 and the center of rotation 13 and changing the depth of the hole 5, could also be combined in that, for example, at the same time the distance is changed and also the depth of the hole 5. Further, also other solutions for changing or adjusting the amount of imbalance are possible for the imbalanced flywheel 3. In addition, the imbalanced vibrating portion mentioned in the present invention must not necessarily be an imbalanced flywheel. The imbalanced vibrating portion could comprise a shape having at least one cut-away portion, wherein the cut-away portion is offset from an axis of rotation of the vibration generating element.

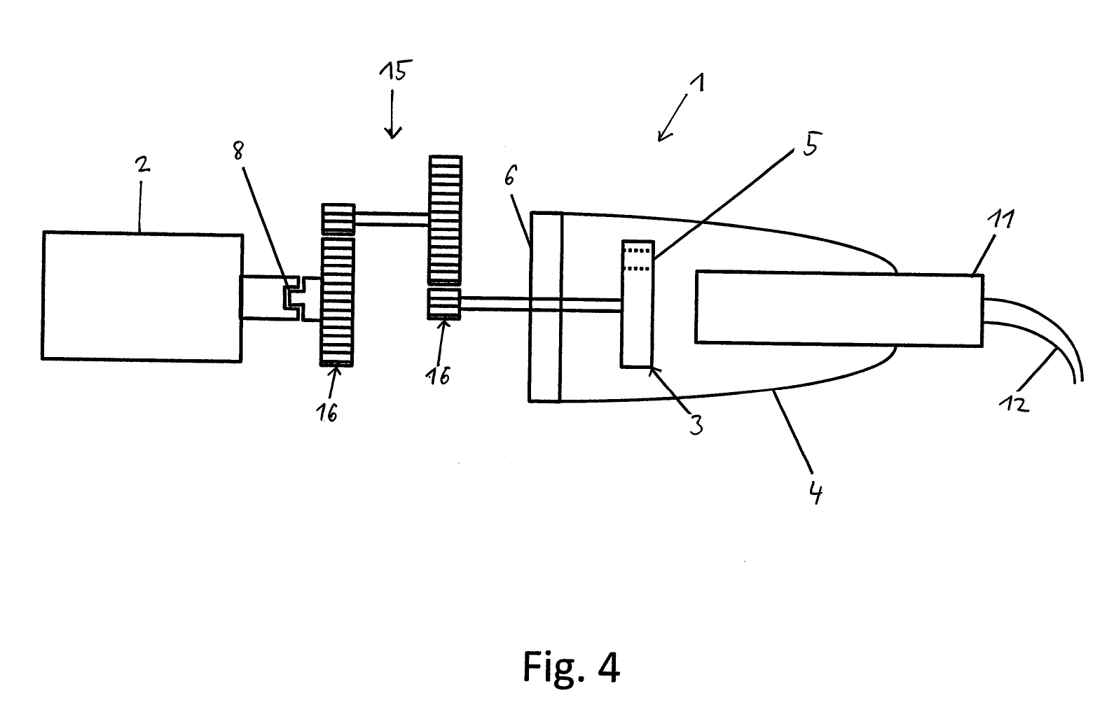

FIG. 4 shows a further dental handpiece 1, which is similar to the dental handpiece 1 in FIG. 1a and comprises similar parts as the dental handpiece 1 in FIG. 1a. In addition, however, the vibration generator of the dental handpiece 1 in FIG. 4 now further comprises a speed-increasing gear 15, which is positioned between the motor 2 and the vibration generating element respectively the imbalanced flywheel 3.

The speed-increasing gear 15 is used in the vibration generator of the dental handpiece 1 of FIG. 4, since the substances contained in the container 11, as for example a restoration composite, currently often operates at a vibrational frequency of about 6 kHz, such as the SONICfill products. That means that the viscosity of the substance is in particular reduced by supplying vibration energy at a vibrational frequency of about 6 kHz. To match this frequency with a direct-drive device, such as illustrated in FIG. 1a, a motor would be required that spins at 6 kHz or 360,000 rpm. However, most of the dental motors currently used cannot exceed 30,000-40,000 rpm. To offer the possibility of still using a normal dental motor, the speed-increasing gear 15 is provided between the motor 2 and the imbalanced flywheel 3. The speed-increasing gear 15 in FIG. 4 thereby comprises a gear train of two consecutive speed-increasing gears 16. This is due to the fact that with the common dental motors with 30,000-40,000 rpm a 9:1 speed-increasing gear train is necessary to get a frequency of 6 kHz. In the vibration generator of the dental handpiece 1 in FIG. 4, the speed-increasing gear 15 comprises a gear train of two consecutive 3:1 speed increasing gears 16 by which a total speed increase of 9:1 is achieved.

However, although the current formulation of the SONICfill composite is optimized for use at 6 kHz, it is possible to formulate composites that exhibit substantial thixotropic properties at substantially higher or lower frequencies, as will be understood by those skilled in the art. For example, a composite that works sufficiently well at 600 Hz would not require the inclusion of the speed increasing gear 15 in the dental handpiece 1, because a direct drive with a 36,000 rpm motor 2 would suffice.

It should be noted that such a the speed-increasing gear 15 could be also applied to a dental handpiece 1 which is a dental scaler as shown in FIG. 1b, even so the dental handpiece 1 in FIG. 1b does not comprise a container with restoration composites.

In the vibration generators of the dental handpieces 1 of the FIGS. 1a, 1b and 4, it is possible to change or adjust the amplitude of the vibration by changing or adjusting the imbalance of the imbalanced flywheel 3, as described above. Additionally the amplitude of the vibration could be also changed or adjusted by changing the speed of the motor 2. However, this will also change the frequency, which may not always be desirable, depending on the frequency response of the viscosity of the restoration composite.

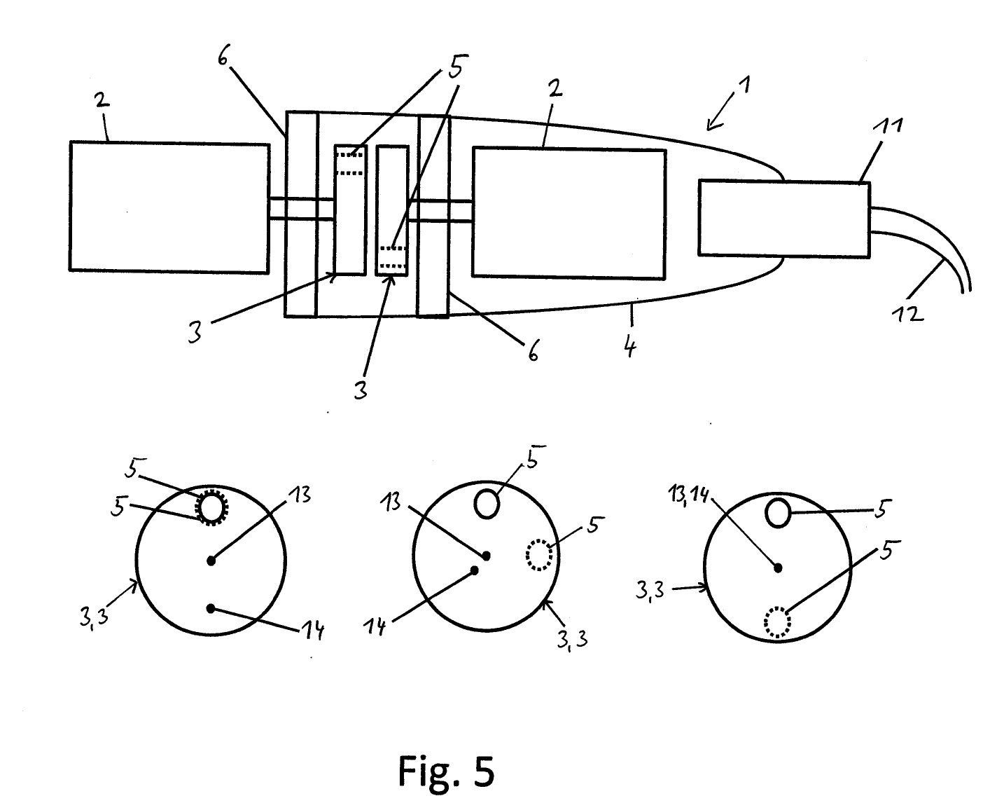

The vibration generator of the dental handpiece 1 shown in the top of FIG. 5 therefore has two vibration generating elements, a first one and a second one, wherein each vibration generating element comprises an imbalanced flywheel 3 and is in mechanical communication with the vibrating element 4. It should be noted that the dental handpiece 1 shown in the top of FIG. 5 comprises a couple of similar parts as the dental handpieces 1 in the FIGS. 1a, 1b and 4.

The first and second imbalanced flywheels 3 in the top of FIG. 5 correspond to the imbalanced flywheel 3 in the FIGS. 1a, 1b and 4 and thus, similar as in view of the imbalanced flywheel 3 in the FIGS. 1a, 1b and 4, also the rotation of the first and second imbalanced flywheels 3 in FIG. 5 generate vibrations of the vibrating element 4. As can be seen from the top of FIG. 5, the second imbalanced flywheel 3 is rotationally coupled to a second motor 2 and similar as in the FIGS. 1a and 1b the first imbalanced flywheel 3 is rotationally coupled to a first motor 2. That means that the first vibration generating element is rotationally coupled to the first rotation driving means 2 and comprises a first imbalanced vibrating portion 3 and the second vibration generating element is rotationally coupled to the second rotation driving means 2 and comprises a second imbalanced vibrating portion 3 and the vibrating element 4 is in mechanical communication with the first vibration generating element and with the second vibration generating element and the rotation of the first vibration generating element causes the first imbalanced vibrating portion 3 to generate vibrations of the vibrating element 4 and the rotation of the second vibration generating element causes the second imbalanced vibrating portion 3 to generate vibrations of the vibrating element 4.

With the use of two imbalanced flywheels 3 instead of one, which are spun by two different motors 2, it is now possible to adjust the amplitude of the vibration while keeping the frequency constant. The change or adjustment of the amplitude of the vibration by keeping the frequency constant is thereby achieved in that the rotational speeds of the two vibration generating elements and therefore of the two imbalanced flywheels 3 are the same and the vibration generator further comprises means for adjusting a phase between rotational movements of the two vibration generating elements respectively the two imbalanced flywheels 3.

This could be for example achieved if the two motors 2 are independently driven and the motors 2 are AC motors by which the relative phase of rotation of the two imbalanced flywheels 3 can be changed. Since the rotor of an AC motor 2 is phase-locked to the AC voltage driving it, the rotational phase of each motor 2—and thus the rotational phase of each imbalanced flywheel 3—can be controlled by controlling the phase of the AC drive voltage of each motor 2.

As shown in the bottom part of FIG. 5, the maximum vibration is obtained by rotating the two imbalanced flywheels 3 in-phase, thus causing a strong imbalance. This is illustrated on the left side of the bottom part of FIG. 5, where the two imbalanced flywheels 3 are shown in-phase so that the holes 5 of the two imbalanced flywheels 3 are lying upon each other and the center of mass 14 of both imbalanced flying wheels is far away of the center of rotation 13 of both imbalanced flywheels 3.

On the other hand, zero vibration can be obtained by rotating the imbalanced flywheels 3 180° out of phase, thus causing a balanced state without any imbalance. This is illustrated on the right side of the bottom part of FIG. 5, where the holes are shifted by 180° and thus the center of mass 14 of both imbalanced flywheels 3 in combination corresponds to the center of rotation 13 of both imbalanced flywheels 3.

An intermediate-amplitude vibration is obtained, for example, by rotating the imbalanced flywheels 3 90° (or any other angle between 0° and 180°) out of phase, as shown in the middle of the bottom part of FIG. 5 where the holes 5 are shifted by 90° and thus the center of mass 14 of both imbalanced flywheels is out of the center of rotation 13 of both imbalanced flywheels 3 but not as far as on the left side of the bottom part of FIG. 5.

Preferably the two vibration generating elements in FIG. 5 have identical imbalanced vibrating portions and thus identical imbalanced flywheels 3.

It should be mentioned that in the exemplary vibration generator of the dental handpiece 1 of FIG. 5, both imbalanced flywheels 3 are directly driven by the motors 2, in which case a simple design choice would be to place the motor 2 of the second imbalanced flywheel 3 towards the distal end of the handpiece. However, it is also possible to place both motors 2 on the coupler end of the dental handpiece 1 and convey the rotation using gears. In addition, it would also be possible to provide any kind of speed-increasing gear 15, for example the one shown in FIG. 4, between the first motor 2 and the first imbalanced flywheel 3 as well as between the second motor 2 and the second imbalanced flywheel 3.

The above-described adjustment of the amplitude of the vibration in the vibration generator of the dental handpiece 1 shown in FIG. 5 is an amplitude adjustment using varying electric phases. Alternatively or in addition, a mechanical amplitude adjustment using a phase-adjustment gear would also be possible.

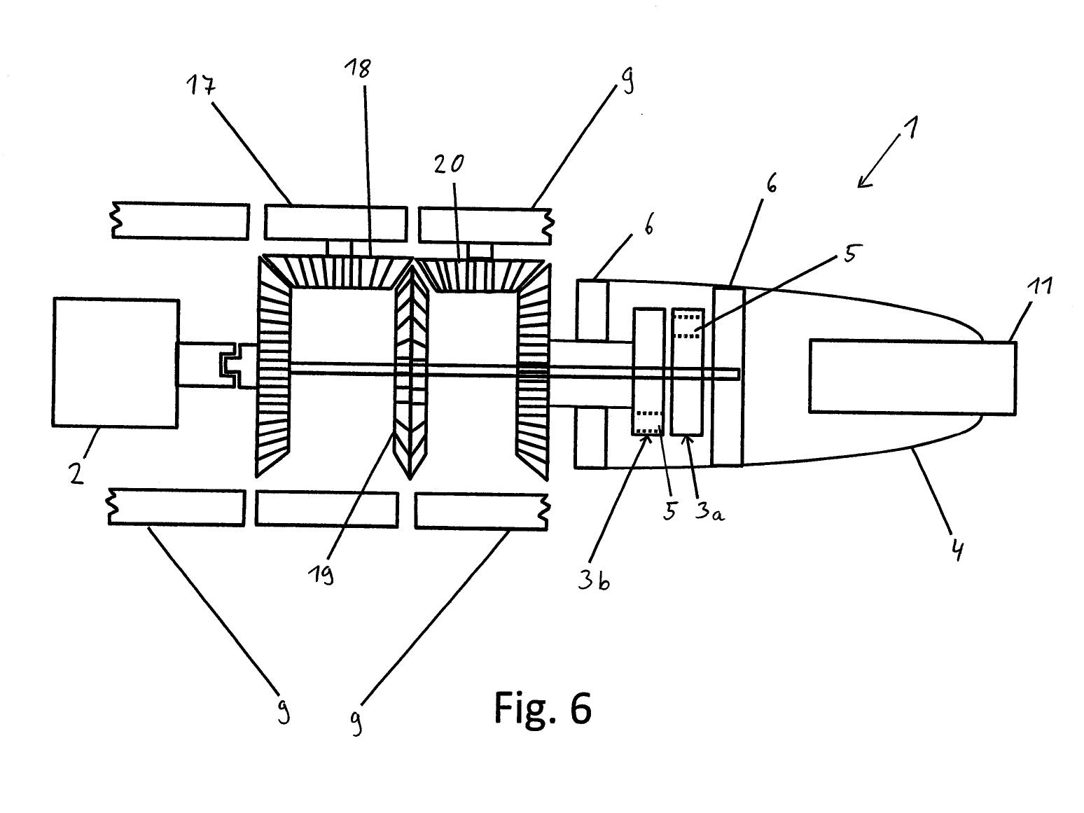

A corresponding dental piece 1 with a vibration generator that uses an exemplary mechanical amplitude adjustment is shown in the FIGS. 6, 7 and 8. It should be noted that the dental handpiece 1 shown in the FIGS. 6, 7 and 8 comprises a couple of similar parts as the dental handpieces 1 in the FIGS. 1a, 1b and 4.

Again, similar to FIG. 5, in the FIGS. 6, 7 and 8 the vibration generator comprises a first vibration generating element and second vibration generating element, with a first imbalanced flywheel 3a and a second imbalanced flywheel 3b. Similar as in the FIGS. 1a, 1b and 4, the first vibration generating element is rotationally coupled to a motor 2. The second vibration generating element is rotationally coupled to a driving shaft of the rotation driving means, which is the motor 2, wherein in difference to the vibration generator of FIG. 5 the motor 2 spins the first and second imbalanced flywheels 3a and 3b. Again, the vibrating element 4 supports the first and second vibration generating elements.

Further, the vibration generator comprises means for adjusting a phase of the rotational movement of the two vibration generating elements. The means for adjusting a phase comprises a gear train transferring a rotation of the drive shaft to the second vibration generating element and thus the second imbalanced flywheel 3b, wherein the gear train comprises a phase-adjustment gear portion 18. The phase-adjustment gear portion 18 in particular comprises a bevel gear arrangement, wherein one beveled gear wheel of the beveled gear arrangement is displaceable around a longitudinal axis of the gear train to adjust a phase of rotation of the corresponding vibration generating element respectively imbalanced flywheel 3b.

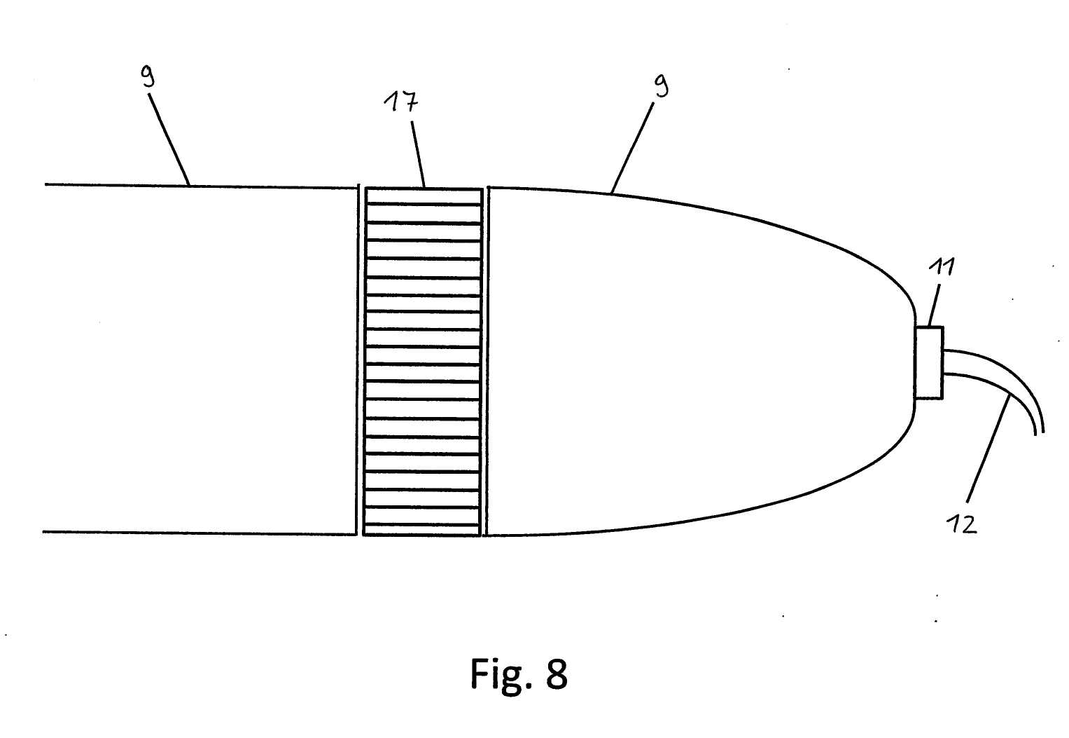

In FIGS. 6, 7 and 8 a user-rotated amplitude adjustment ring 17 is then positioned on the outside of the dental handpiece, wherein, as can in particular be seen in FIG. 8, the amplitude adjustment ring 17 is surrounded on the outside of the dental handpiece 1 by the outer case 9. On the inside of the amplitude adjustment ring 17, the phase-adjustment gear portion 18 is mounted, wherein a bearing is not directly shown. A transmission gear 19, wherein a bearing is again not shown, transmits then the motion of the phase-adjustment gear portion 18 to a direction-reversal gear 20, which transmits the motion to a further bevel gear attached to the second imbalanced flywheel 3b.

On the other side, the first imbalanced flywheel 3a is directly driven by the motor 2.

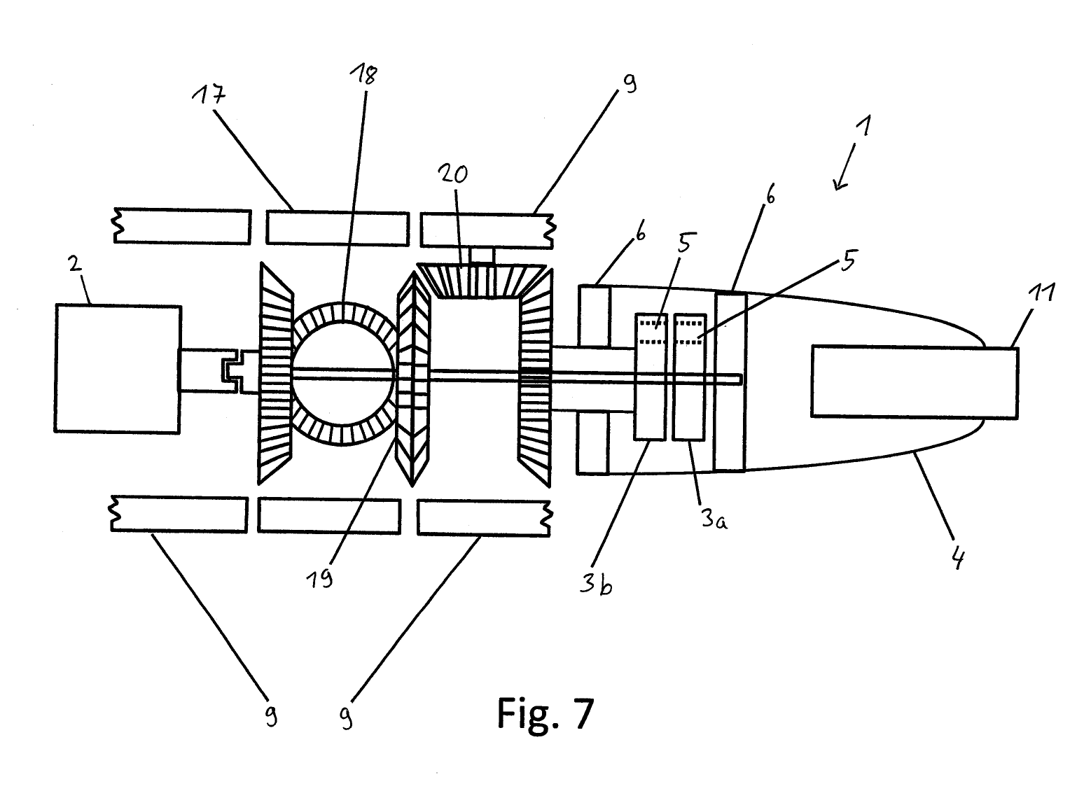

To adjust the relative phase of the two imbalanced flywheels 3a and 3b, the amplitude adjustment ring 17 is rotated through which the phase-adjustment gear portion 18 and thus in particular the one beveled gear wheel of the bevel gear arrangement of the phase-adjustment gear 18 is moved to a different location around the perimeter of the transmission gear 19, as it is shown in the FIGS. 6 and 7. From both figures, it is derivable that the position of the hole 5 of the second imbalanced flywheel 3b is moved through rotating the amplitude adjustment ring 17.

Regarding the relative phase of the two imbalanced flywheels 3a and 3b and the impact on the imbalance of both imbalanced flywheels 3a and 3b, it is referred to the explanations to the bottom part of FIG. 5, where it is explained in detail which impact different relative phases have.

It should be noted that the amplitude adjustments described above in view of the FIGS. 5-8 could be also applied to a dental handpiece 1 which is a dental scaler as shown in FIG. 1b. In addition, a further combination with the speed-increasing gear 15 shown in FIG. 4 would then be also possible.

The present invention further describes a method for manufacturing a corresponding dental handpiece, wherein the method comprises the steps of providing a rotation driving means, imbalancing an object, e.g. drilling or milling a hole or pocket in it or grinding off part of it, to form an imbalanced vibrating portion, providing a vibration generating element rotationally coupled to the rotation driving means and comprising the imbalanced vibrating portion and providing a vibrating element in mechanical communication with the vibration generating element. The rotation of the vibration generating element causes the imbalanced vibrating portion to generate vibrations of the vibrating element, wherein the vibrating element is configured to deliver the vibrations to an object.

Summarizing the above, the present invention describes an alternative solution for generating vibrations for a dental handpiece instead of the currently known pneumatic devices or piezo devices. Various features and advantages of the invention are set forth in the following claims.

What is claimed is:

1. A vibration generator for generating mechanical vibrations for a dental handpiece, comprising
a rotation driving means;
a vibration generating element rotationally coupled to the rotation driving means and including an imbalanced vibrating portion; and
a vibrating element in mechanical communication with the vibration generating element,
wherein the rotation of the vibration generating element causes the imbalanced vibrating portion to generate vibrations of the vibrating element, and wherein the vibrating element is configured to deliver the vibrations to an object.

2. The vibration generator according to claim 1, wherein the imbalanced vibrating portion includes an imbalanced flywheel formed by a disc comprising at least one imbalancing hole or opening, the imbalancing hole or opening being offset from an axis of rotation of the vibration generating element.

3. The vibration generator according to claim 1, wherein the imbalanced vibrating portion comprises a shape having at least one cut-away portion, the cut-away portion being offset from an axis of rotation of the vibration generating element.

4. The vibration generator according to claim 1, further comprising at least one speed-increasing gear provided between the rotation driving means and the vibration generating element, the at least one speed-increasing gear comprising a gear train of at least two consecutive speed-increasing gears provided between the rotation driving means and the vibration generating element.

5. The vibration generator according to claim 1, further comprising
a second vibration generating element in mechanical communication with the vibrating element,
wherein the rotation of the second vibration generating element generates vibrations of the vibrating element.

6. The vibration generator according to claim 5, wherein the rotational speeds of the two vibration generating elements are the same, the vibration generator further comprising means for adjusting a phase between rotational movements of the two vibration generating elements.

7. The vibration generator according to claim 1, further comprising
a second vibration generating element rotationally coupled to a driving shaft of the rotation driving means, wherein the vibrating element supports the first and second vibration generating elements, and
a means for adjusting a phase of the rotational movement of the two vibration generating elements.

8. The vibration generator according to claim 7,
wherein the means for adjusting a phase of the rotational movement of the two vibration generating elements comprise a gear train transferring a rotation of the drive shaft to one of the two vibration generating elements, the gear train comprising a phase-adjustment gear portion, the phase-adjustment gear portion in particular comprising a bevel gear arrangement, one beveled gearwheel of the bevel gear arrangement being displaceable around a longitudinal axis of the gear train to adjust a phase of rotation of the corresponding vibration generating element.

9. The vibration generator according to claim 1, wherein the rotation driving means comprises an electric motor.

10. The vibration generator according to claim 1, wherein the vibrations have a displacement amplitude between 5 micrometers and 500 micrometers.

11. The vibration generator according to claim 10, wherein the vibrations have a displacement amplitude between 50 micrometers and 200 micrometers.

12. The vibration generator according claim 11, wherein the vibrations have a displacement amplitude of approximately 100 micrometers.

13. The vibration generator according to claim 1, wherein the object comprises a container containing a substance having a physical property that changes under vibration, the physical property in particular comprising a viscosity, and the object further comprises a tip for providing the substance.

14. The vibration generator according to claim 1, wherein the object comprises a vibratable treatment instrument, in particular a scaler tip, and a tooth in a patient's oral cavity.

15. A dental handpiece for dispensing a pasty filler mass the viscosity of which can be reduced by supplying vibration energy, the handpiece comprising:
a handpiece housing;
a means for holding a container for the pasty filler mass; and
the vibration generator of claim 1.

16. A dental handpiece comprising:
an elongated gripping sleeve;
a vibratable treatment instrument including a scaler tip arranged at one end of the gripping sleeve; and
the vibration generator of claim 1 arranged in the gripping sleeve to generate vibrations.

17. The dental handpiece according to claim 16, the handpiece being a dental scaler.

18. A method of manufacturing a dental handpiece, comprising:
providing a rotation driving means;
imbalancing an object to form an imbalanced vibrating portion;
providing a vibration generating element rotationally coupled to the rotation driving means and comprising the imbalanced vibrating portion; and
providing a vibrating element in mechanical communication with the vibration generating element,
wherein the rotation of the vibration generating element causes the imbalanced vibrating portion to generate vibrations of the vibrating element, the vibrating element configured to deliver the vibrations to an object.
